(19) United States
(12) Patent Application Publication
(10) Pub. No.: US 2016/0234577 A1
(43) Pub. Date: Aug. 11, 2016

(54) WAVELENGTH ROUTING DEVICE

(71) Applicant: HUAWEI TECHNOLOGIES CO.,LTD., Shenzhen (CN)

(72) Inventors: Chen Qiu, Hangzhou (CN); Qinfen Hao, Beijing (CN); Yaoda Liu, Shenzhen (CN)

(73) Assignee: HUAWEI TECHNOLOGIES CO.,LTD., Shenzhen (CN)

(21) Appl. No.: 15/132,621

(22) Filed: Apr. 19, 2016

Related U.S. Application Data
(63) Continuation of application No. PCT/CN2013/001341, filed on Nov. 5, 2013.

(51) Int. Cl. H04Q 11/00

(52) U.S. Cl. CPC H04Q 11/0005; H04Q 2011/0009

(57) ABSTRACT

A wavelength routing device is disclosed, wherein the device includes: a primary circuit, and a secondary circuit, where the primary circuit includes N 2×2 wavelength switches, the secondary circuit includes two N×N wavelength routers, and each N×N wavelength router includes at least one 2×2 wavelength switch, where a value of N is 2ⁿ, n being a positive integer; and an input port of each 2×2 wavelength switch in the primary circuit is connected to an input stage, an output port of each 2×2 wavelength switch is connected to an input port of an N×N wavelength router of the secondary circuit, and an output port of the N×N wavelength router of the secondary circuit is connected to an output stage.

### CROSS-REFERENCE TO RELATED APPLICATIONS

This application is a continuation of International Application No. PCT/CN2013/001341, filed on Nov. 5, 2013, which is hereby incorporated by reference in its entirety.

### TECHNICAL FIELD

The present disclosure relates to optical network technologies, and in particular, to a wavelength routing device based on a wavelength cross filter.

### BACKGROUND

An optical router is an important constituent part of an optical interconnection technology, and can connect transmit and receive nodes, so that an optical signal sent from the transmit node is accurately transmitted to the receive node. Optical routers can be mainly divided into two categories: a spatial router based on a spatial optical switch and a wavelength router based on a wavelength optical switch, where the wavelength router becomes a research hotspot because the wavelength router can implement self-routing of optical signal without the need to perform dynamic adjustment. An optical router based on a wavelength cross filter uses periodic characteristics of spectrum filtering of the wavelength cross filter, and therefore can effectively reduce a quantity of switch nodes in an optical wavelength router and reduce the size and time delay of the router.

In the prior art, a topology of an optical router based on a wavelength cross filter is shown in FIG. 1, and FIG. 1 is a diagram of a 9×9 topology in a Recursive wavelength-routed optical network (WRON-RC) technology. A routing table of an optical switch node of each stage is shown in FIG. 2. As can be learned from FIG. 2, for a switch node Λ_{A}, responses of the switch node to optical signal with wavelengths of λ0, λ3, and λ6 are cross, and responses to optical signal with wavelengths of λJ, λ2, λ4, λ5, λ7, and λ8 are bar. In the diagram of the 9×9 topology, when optical signal with a different wavelength is input from an input port, for example I₀, and optical signal with a wavelength is output from an output port, for example O₈, optical signal needs to pass through four optical switches to finally output optical signal with a particular wavelength.

However, in the prior art, an optical router based on a wavelength cross filter still has a very complex topology, and a large quantity of optical switches are needed in a wavelength router.

### SUMMARY

The present disclosure provides a wavelength routing device, which simplifies a topology of a wavelength routing device, and reduces a quantity of optical switch nodes in the wavelength routing device.

An embodiment of the present disclosure provides a wavelength routing device, including:

a primary circuit and a secondary circuit, where the primary circuit includes N 2×2 wavelength switches, the secondary circuit includes two N×N wavelength routers, and each N×N wavelength router includes at least one 2×2 wavelength switch, where a value of N is 2ⁿ, n being a positive integer; and in the primary circuit, an input port of each 2×2 wavelength switch is connected to an input stage and an output port of each 2×2 wavelength switch is connected to an input port of an N×N wavelength router of the secondary circuit, and output ports of the N×N wavelength routers of the secondary circuit are connected to an output stage.

Further, the input stage includes 2N input ports, where the input ports in the input stage are correspondingly and separately connected to the input ports of the 2×2 wavelength switches in the primary circuit, and the output ports of the 2×2 wavelength switches in the primary circuit are correspondingly connected to the input ports of the N×N wavelength routers in the secondary circuit separately.

Further, the output stage includes 2N output ports, where the output ports in the output stage are correspondingly and separately connected to the output ports of the N×N wavelength routers in the secondary circuit.

Further, a quantity N1 of 2×2 wavelength switches in the wavelength routing device is determined by using a formula (1):

N1=(M1/2)log₂ M1 (1)

where M1 is a quantity of the input ports in the input stage or a quantity of the output ports in the output stage.

Further, in the wavelength routing device, a quantity N2 of 2×2 wavelength switches that input optical signal needs to pass through from an input port of the input stage to a specified output port of the output stage is determined by using a formula (2):

N1=log₂ M2 (2)

where M2 is the quantity of the input ports or the quantity of the output ports.

According to the wavelength routing device provided in the embodiments of the present disclosure, in the device, the primary circuit includes N 2×2 wavelength switches and the secondary circuit includes two N×N wavelength routers, which simplifies a topology of the wavelength routing device, and reduces a quantity of optical switch nodes in the wavelength routing device.

### BRIEF DESCRIPTION OF DRAWINGS

To describe the technical solutions in the embodiments of the present disclosure or in the prior art more clearly, the following briefly describes the accompanying drawings required for describing the embodiments or the prior art.

FIG. 1 is a schematic diagram of a topology of a routing device in the prior art;

FIG. 2 is a schematic diagram of a routing table of wavelength switches of the routing device in FIG. 1;

FIG. 3 is a schematic structural diagram of a wavelength routing device according to Embodiment 1 of the present disclosure;

FIG. 4 is a schematic structural diagram of a 2×2 wavelength switch of the wavelength routing device according to Embodiment 1 of the present disclosure;

FIG. 5 is a first schematic diagram of input optical signal with the spectrum of a wavelength routing device according to the present disclosure;

FIG. 6A to FIG. 6D are schematic diagrams of spectral responses of output ports to input ports of a 2×2 wavelength switch in a primary circuit of the wavelength routing device according to Embodiment 1 of the present disclosure;

FIG. 7 is a schematic structural diagram of a wavelength routing device according to Embodiment 2 of the present disclosure;

FIG. 8 is a schematic structural diagram of a 2×2 wavelength switch of the wavelength routing device according to Embodiment 2 of the present disclosure;

FIG. 9 is a second schematic diagram of input optical signal with the spectrum of a wavelength routing device according to the present disclosure;

FIG. 10A to FIG. 10D are schematic diagrams of spectral responses of output ports to input ports of a 2×2 wavelength switch in a primary circuit of the wavelength routing device according to Embodiment 2 of the present disclosure;

FIG. 10E to FIG. 10H are schematic diagrams of spectral responses of output ports to input ports of a 2×2 wavelength switch in a secondary circuit of the wavelength routing device according to Embodiment 2 of the present disclosure; and

FIG. 11 is a schematic structural diagram of a wavelength routing device according to Embodiment 3 of the present disclosure.

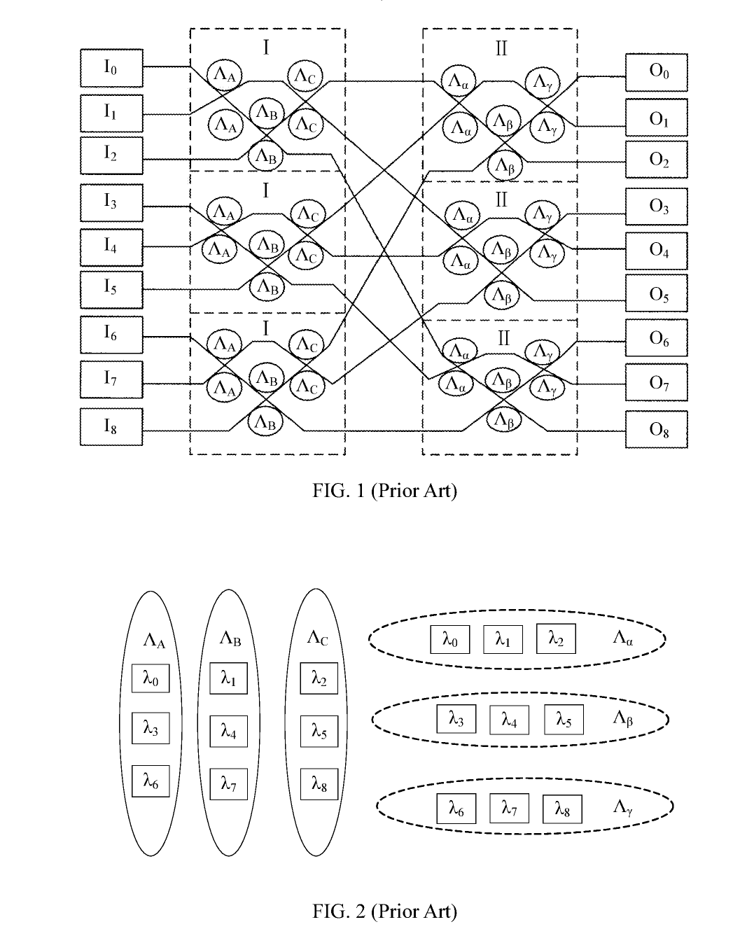

### DESCRIPTION OF EMBODIMENTS

To make the objectives, technical solutions, and advantages of the embodiments of the present disclosure clearer, the following clearly describes the technical solutions in the embodiments of the present disclosure with reference to the accompanying drawings in the embodiments of the present disclosure.

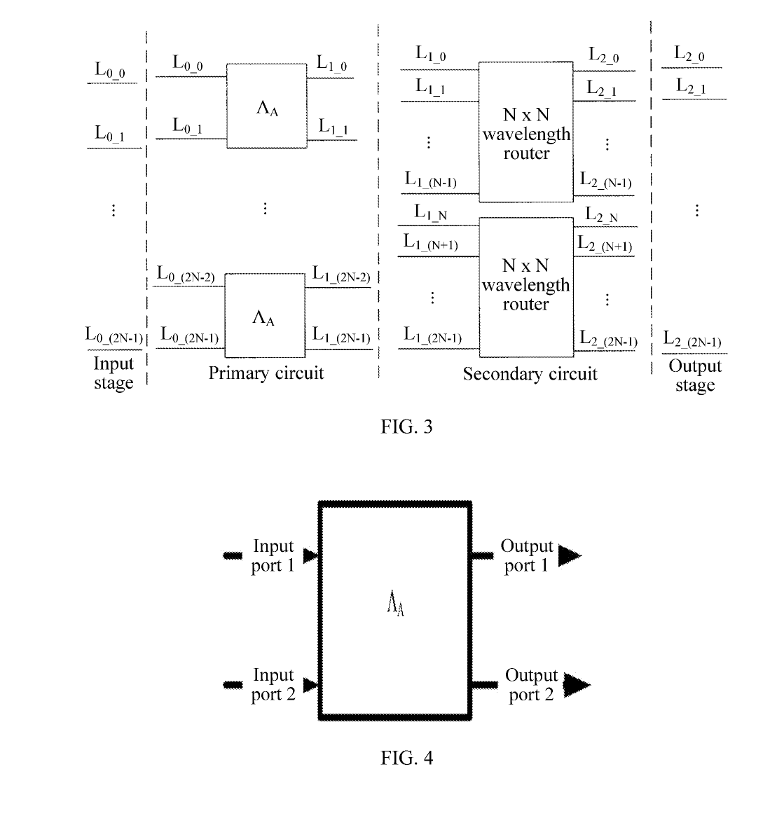

FIG. 3 is a schematic structural diagram of a wavelength routing device according to Embodiment 1 of the present disclosure, and FIG. 4 is a schematic structural diagram of a 2×2 wavelength switch of the wavelength routing device according to Embodiment 1 of the present disclosure. The routing device provided in this embodiment is a wavelength router based on a wavelength optical switch, is applicable to an optical interconnection technology, and can implement transmission of an optical signal between transmit and receive nodes. Referring to FIG. 3 and FIG. 4, the wavelength routing device of this embodiment may include: a primary circuit and a secondary circuit.

The primary circuit includes N 2×2 wavelength switches Λ_{A}, the secondary circuit includes two N×N wavelength routers, and each N×N wavelength router includes at least one 2×2 wavelength switch Λ_{A}, where a value of N is 2ⁿ, n being a positive integer.

In this embodiment, the N 2×2 wavelength switches Λ_{A} and the two N×N wavelength routers are combined to form one 2N×2N wavelength routing device. For example, when the value of N is 2, a 4×4 wavelength routing device includes two 2×2 wavelength switches Λ_{A} and two 2×2 wavelength routers. In this case, each 2×2 wavelength router includes only one 2×2 wavelength switch Λ_{A}, and therefore, it may be considered that the 4×4 wavelength routing device includes four 2×2 wavelength switches Λ_{A}. When the value of N is 4, an 8×8 wavelength routing device includes 4 2×2 wavelength switches Λ_{A} and two 4×4 wavelength routers, and the corresponding 4×4 wavelength routing device when the value of N is 2 may be used as the 4×4 wavelength router, and in this case, the 4×4 wavelength router includes four 2×2 wavelength switches Λ_{A}. Correspondingly, a 16×16 wavelength routing device includes eight 2×2 wavelength switches Λ_{A} and two 8×8 wavelength routers, where the composition of the 8×8 wavelength router is the same as the composition of the 8×8 wavelength routing device.

In this embodiment, in the primary circuit, an input port of each 2×2 wavelength switch Λ_{A} is connected to an input stage and an output port of each 2×2 wavelength switch Λ_{A} is connected to an input port of an N×N wavelength router of the secondary circuit, and output ports of the N×N wavelength routers of the secondary circuit are connected to an output stage. Further, in this embodiment, each 2×2 wavelength switch Λ_{A} includes two input ports and two output ports (for example, input port 1, input port 2, output port 1, and output port 2 shown in FIG. 4). The input stage includes 2N input ports, for example, input ports L₀_{_}₀ to L₀_{_}_{(2N-1)} of the input stage in FIG. 3. The input ports in the input stage are correspondingly and separately connected to the input ports of the 2×2 wavelength switches Λ_{A}, i.e., every two input ports in the input stage are correspondingly and separately connected to the two input ports of a 2×2 wavelength switch Λ_{A} in FIG. 4. The output ports (for example, L1_0 to L₁_{_}_{(2N-1)} in the primary circuit in FIG. 3) of the 2×2 wavelength switches Λ_{A} are correspondingly and separately connected to the input ports (for example, L₁_{_}₀ to L₁_{_}_{(2N-1)} in the secondary circuit in FIG. 3) of the N×N wavelength routers in the secondary circuit. Each N×N wavelength router includes N input ports and N output ports. The output stage includes 2N output ports, for example, output ports L₂_{_}₀ to L₂_{_}_{(2N-1)} in the output stage in FIG. 3. The output ports of the output stage are correspondingly and separately connected to output ports (for example, L₂_{_}₀ to L₂_{_}_{(2N-1)} in the secondary circuit in FIG. 3) of the N×N wavelength routers of the secondary circuit. For example, when the value of N is 4, for an 8×8 wavelength routing device, a quantity of the input ports of the input stage and a quantity of the ports of the output stage are both 8, and each 4×4 wavelength router has four input ports and four output ports.

According to the wavelength routing device provided in this embodiment of the present disclosure, in the device, the primary circuit includes N 2×2 wavelength switches and the secondary circuit includes two N×N wavelength routers, which simplifies a topology of the wavelength routing device, and reduces a quantity of optical switch nodes in the wavelength routing device.

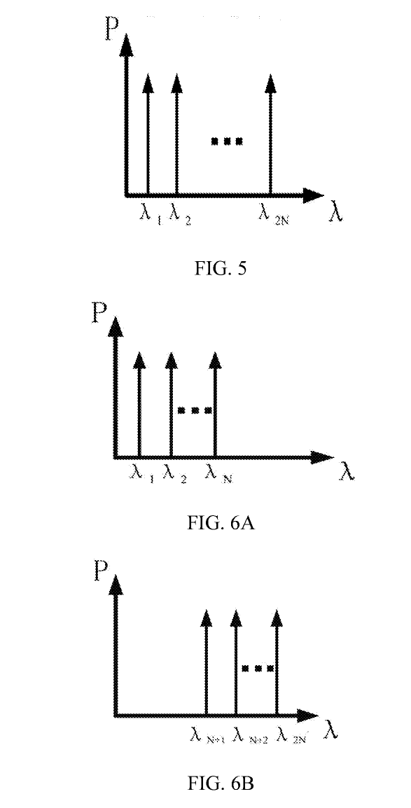

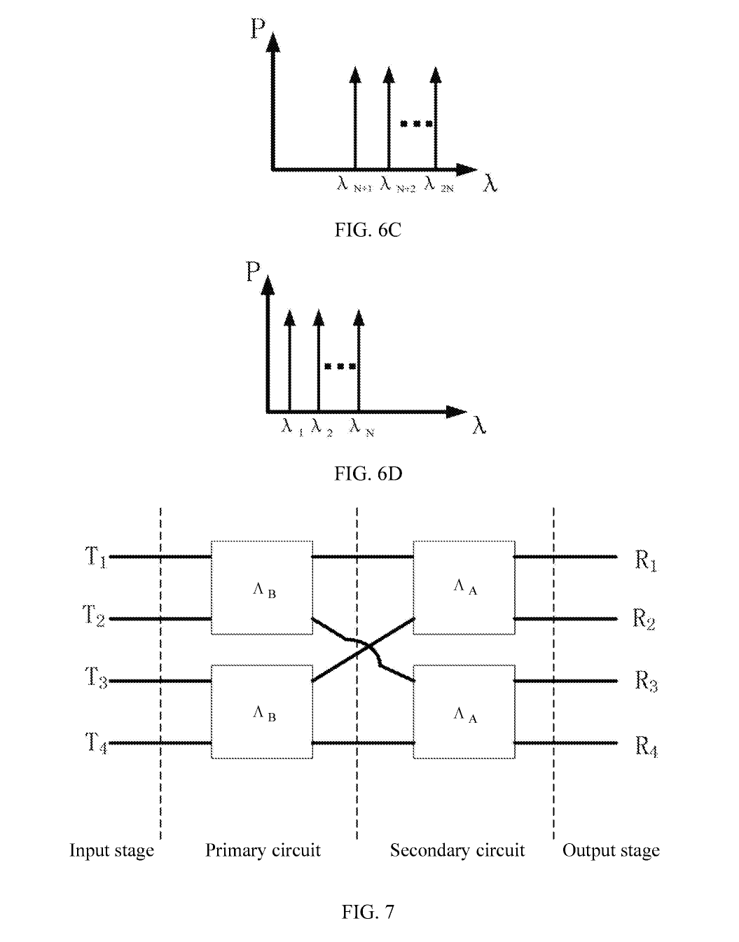

FIG. 5 is a first schematic diagram of input optical signal with the spectrum of a wavelength routing device according to the present disclosure, and FIG. 6A to FIG. 6D are schematic diagrams of spectral responses of output ports to input ports of a 2×2 wavelength switch in a primary circuit of a wavelength routing device according to the present disclosure. Referring to FIG. 5 to FIG. 6D, in this embodiment, a longitudinal coordinate is optical power P and a horizontal coordinate is a wavelength λ in FIG. 5 to FIG. 6D. Further, in the foregoing embodiment, when the input optical signal with the spectrum shown in FIG. 5 is separately input from the ports of the input stage, a spectral response of an output port 1 to an input port 1 in the 2×2 wavelength switch Λ_{A} in the primary circuit is shown in FIG. 6A; a spectral response of an output port 2 to the input port 1 in the 2×2 wavelength switch Λ_{A} in the primary circuit is shown in FIG. 6B, i.e., after the input optical signal with the spectrum enters the input port 1 of the 2×2 wavelength switch Λ_{A}, optical signal with the spectrum output from the output port 1 is λ₁, λ₂, . . . , λ_{N}, and optical signal with the spectrum output from the output port 2 is λ_{N+1}, λ_{N+2}, . . . , λ_{2N}; and correspondingly, a spectral response of the output port 1 to an input port 2 in the 2×2 wavelength switch Λ_{A} in the primary circuit is shown in FIG. 6C, and a spectral response of the output port 2 to the input port 2 in the 2×2 wavelength switch Λ_{A} in the primary circuit is shown in FIG. 6D, i.e., after input optical signal with the spectrum shown in FIG. 5 enters the input port 2 of the 2×2 wavelength switch Λ_{A}, optical signal with the spectrum output from the output port 1 is λ_{N+1}, λ_{N+2}, . . . , λ_{2N}, and optical signal with the spectrum output from the output port 2 is λ₁, λ₂, . . . , λ_{N}.

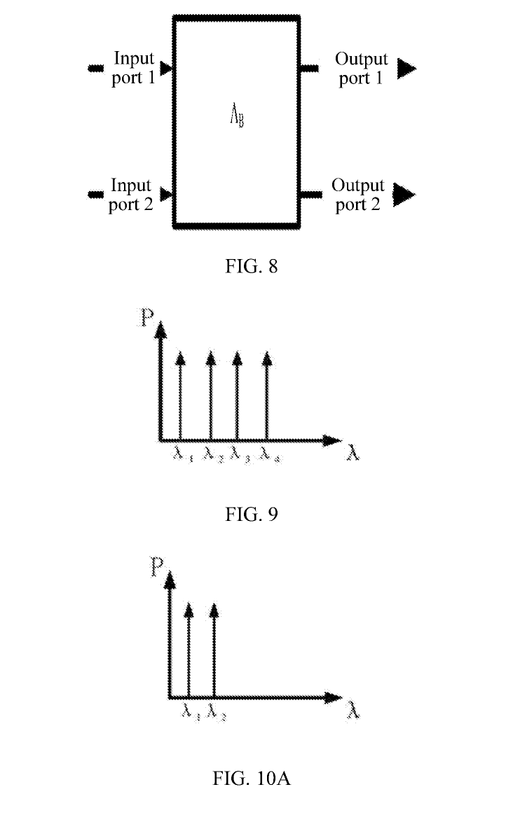

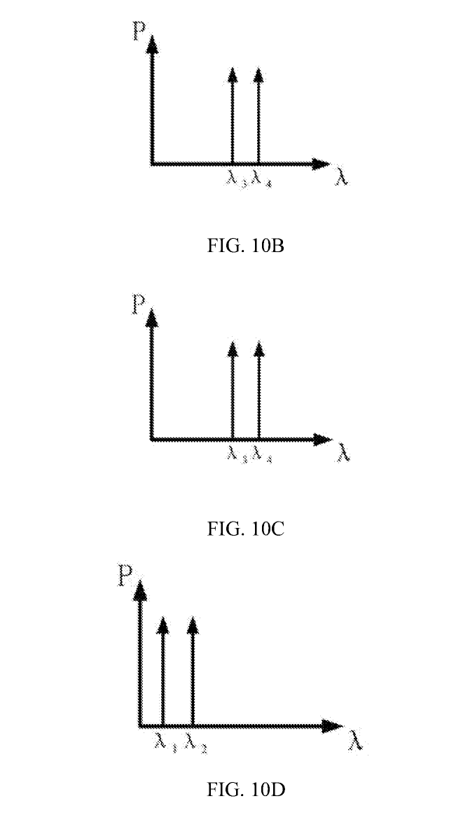

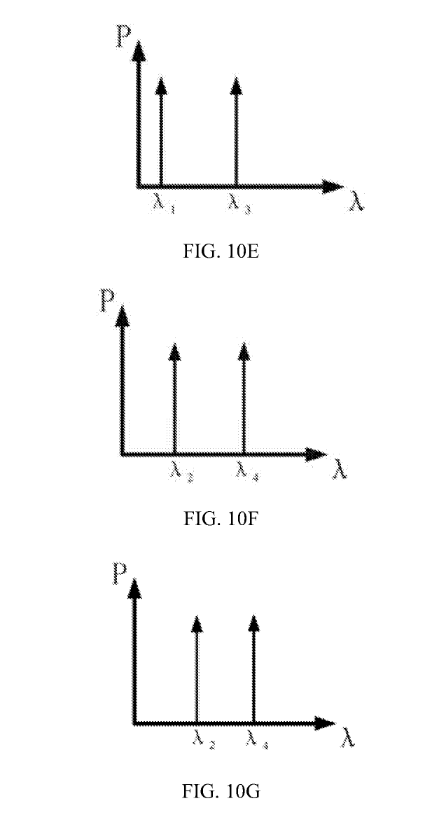

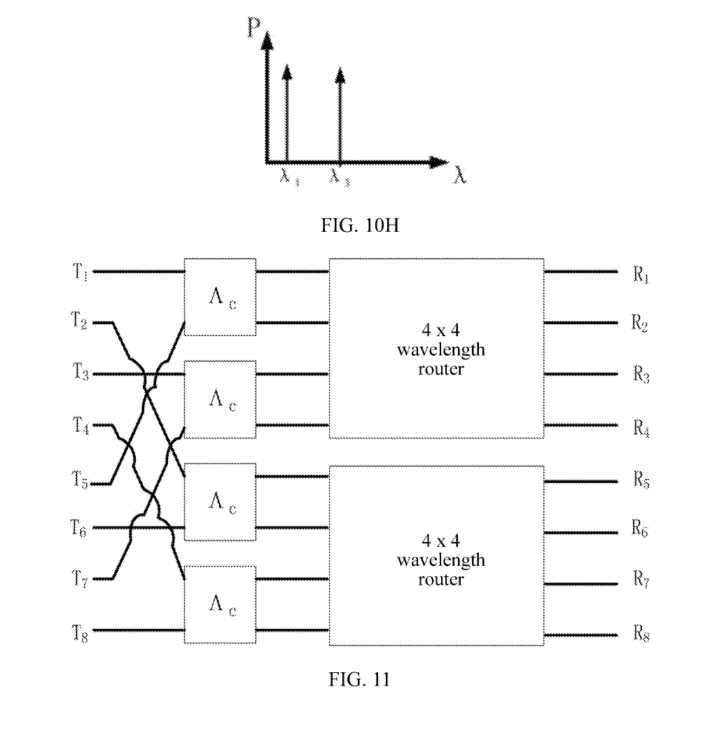

FIG. 7 is a schematic structural diagram of a wavelength routing device according to Embodiment 2 of the present disclosure. FIG. 8 is a schematic structural diagram of a 2×2 wavelength switch of the wavelength routing device according to Embodiment 2 of the present disclosure. FIG. 9 is a second schematic diagram of input optical signal with the spectrum of a wavelength routing device according to the present disclosure, FIG. 10A to FIG. 10D are schematic diagrams of spectral responses of output ports to input ports of a 2×2 wavelength switch in a primary circuit of the wavelength routing device according to Embodiment 2 of the present disclosure. FIG. 10E to FIG. 10H are schematic diagrams of spectral responses of output ports to input ports of a 2×2 wavelength switch in a secondary circuit of the wavelength routing device according to Embodiment 2 of the present disclosure.

Based on the foregoing embodiments, in this embodiment, when a value of N is 2, a structure of a corresponding 4×4 wavelength routing device is shown in FIG. 7. The 4×4 wavelength routing device includes two 2×2 wavelength switches Λ_{B} in a primary circuit and two 2×2 wavelength routers, where each 2×2 wavelength router includes one 2×2 wavelength switch Λ_{A}, and therefore, the 2×2 wavelength switch Λ_{A} is used in this embodiment as the 2×2 router of the secondary circuit. Structures and functions of the 2×2 wavelength switch Λ_{A} and the 2×2 wavelength switch Λ_{B} (as shown in FIG. 8) in this embodiment are the same as those of the 2×2 wavelength switch Λ_{A} in the foregoing embodiments, and therefore, for the 2×2 wavelength switch Λ_{A} in this embodiment, refer to Λ_{A} shown in FIG. 4. Sequences for connecting the 2×2 wavelength switches Λ_{A} and the 2×2 wavelength switches Λ_{B} are interchangeable.

In this embodiment, four input ports in the input stage are represented separately by four nodes, i.e., input nodes T₁, T₂, T₃, and T₄. Correspondingly, four output ports in the output stage are represented by output nodes R₁, R₂, R₃, and R₄. The four input nodes T₁, T₂, T₃, and T₄ are correspondingly connected to input ports of the 2×2 wavelength switches Λ_{B} in the primary circuit, the four nodes R₁, R₂, R₃, and R₄ are correspondingly connected to output nodes of the 2×2 wavelength switches Λ_{A} of the secondary circuit, and the 2×2 wavelength switches Λ_{B} in the primary circuit are cross-connected to the 2×2 wavelength switches Λ_{A} in the secondary circuit shown in FIG. 7.

For example, when optical signal with the spectrum shown in FIG. 9 is separately input from the input nodes in the input stage, a spectral response of an output port 1 to an input port 1 of the 2×2 wavelength switch Λ_{B} in the primary circuit is shown in FIG. 10A, and a spectral response of an output port 2 to the input port 1 of the 2×2 wavelength switch Λ_{B} is shown in FIG. 10B, i.e., when optical signal with the spectrum is input from the input node T₁, wavelengths output from the output port 1 of the 2×2 wavelength switch Λ_{B} are λ₁ and λ₂, and wavelengths output from the output port 2 are λ₃ and λ₄; and a spectral response of the output port 1 to an input port 2 of the 2×2 wavelength switch Λ_{B} in the primary circuit is shown in FIG. 10C, and a spectral response of the output port 2 to the input port 2 of the 2×2 wavelength switch Λ_{B} is shown in FIG. 10D, i.e., when the optical signal with the spectrum is input from the input node T₂, wavelengths output from the output port 1 of the 2×2 wavelength switch Λ_{B} are λ₃ and λ₄, and wavelengths output from the output port 2 are λ₁ and λ₂. After the optical signal with the spectrum passes through the 2×2 wavelength switches Λ_{B} in the primary circuit, λ₁ and λ₂ (input optical signal from T₁) and λ₃ and λ₄ (input optical signal from T₂) that are output from the output port 1 of the 2×2 wavelength switch Λ_{B} in the primary circuit are input to an input port 1 of the 2×2 wavelength switch Λ_{A} in the secondary circuit (as shown in FIG. 4). Correspondingly, λ₃ and λ₄ (input optical signal from T₁) and λ₁ and λ₂ (input optical signal from T₂) that are output from the output port 2 of a 2×2 wavelength switch Λ_{B} in the primary circuit are input into an input port 1 of the other 2×2 wavelength switch Λ_{A} in the secondary circuit (as shown in FIG. 4). A spectral response of an output port 1 to the input port 1 of the 2×2 wavelength switch Λ_{A} in the secondary circuit is shown in FIG. 10E, and a spectral response of an output port 2 to the input port 1 of the 2×2 wavelength switch Λ_{A} is shown in FIG. 10F, i.e., after λ1 and λ2 (input optical signal from T₁) and λ3 and λ4 (the spectrum input from T₂) are input from the input port 1, λ1 (input optical signal from T₁) and λ3 (input optical signal from T₂) are output from the output node R1, and λ₂ (input optical signal from T₁) and λ₄ (input optical signal from T₂) are output from the output node R2. Correspondingly, a spectral response of the output port 1 to an input port 2 of the 2×2 wavelength switch Λ_{A} in the secondary circuit is shown in FIG. 10G, and a spectral response of the output port 2 to the input port 2 is shown in FIG. 10H, i.e., after input from T₃ and T₄ and input from the input port 2 of the 2×2 wavelength switch Λ_{A} in the secondary circuit, λ₂ (input optical signal from T₃) and λ₄ (input optical signal from T₄) are output from the output node R₁, and (input optical signal from T₃) and λ₃ (input optical signal from T₄) are output from the output node R₂.

A routing table of the 4×4 wavelength routing device in this embodiment is shown in Table 1.

TABLE 1
Routing table of 4 × 4 wavelength routing device

Output Port (Rₓ)

| Input Port (Tₓ) | R₁ | R₂ | R₃ | R₄ |
|---|---|---|---|---|
| T₁ | λ₁ | λ₂ | λ₃ | λ₄ |
| T₂ | λ₃ | λ₄ | λ₁ | λ₂ |
| T₃ | λ₂ | λ₁ | λ₄ | λ₃ |
| T₄ | λ₄ | λ₃ | λ₂ | λ₁ |

It can be learned from Table 1 that when the input node T₁ needs to communicate with the output node R₃, the signal can be self-routed to the output node R₃ by means of the 4×4 wavelength routing device of this embodiment by simply modulating a signal onto a carrier with a wavelength of λ₃ at the input node T₁.

According to the wavelength routing device provided in this embodiment of the present disclosure, in the device, the primary circuit includes two 2×2 wavelength switches and the secondary circuit includes two 2×2 wavelength routers, which simplifies a topology of the wavelength routing device, and reduces a quantity of optical switch nodes in the wavelength routing device.

FIG. 11 is a schematic structural diagram of a wavelength routing device according to Embodiment 3 of the present disclosure. Based on the foregoing embodiment, this embodiment provides an 8×8 routing device, i.e., a corresponding routing device when a value of N is 4. As shown in FIG. 11, in this embodiment, the 8×8 routing device includes four 2×2 wavelength switches Λ_{C} of a primary circuit and two 4×4 wavelength routers of a secondary circuit, input nodes T₁ to T₈, and output nodes R₁ to R₈, where a connection relationship between the input nodes T₁ to T₈ and input ports of the four 2×2 wavelength switches Λ_{C} of the primary circuit is shown in FIG. 11, and the connection relationship in the 4×4 routing device in Embodiment 2 is used for the two 4×4 wavelength routers of the secondary circuit. In this embodiment, the 4×4 wavelength router includes four 2×2 wavelength switches Λ_{A} (as shown in FIG. 3), and for a specific implementation manner, refer to the implementation method of Embodiment 2.

Further, based on the foregoing embodiment, in this embodiment, a quantity N1 of 2×2 wavelength switches in the wavelength routing device is determined by using a formula (1):

N1=(M1/2)log₂ M1 (1)

A quantity N2 of 2×2 wavelength switches that input optical signal needs to pass through from an input port (for example, nodes T₁ to T₈) of the input stage to a specified output port (for example, nodes R₁ to R₈) of the output stage is determined by using a formula (2):

N1=log₂ M2 (2)

where M1 is a quantity of input ports in the input stage or a quantity of output ports in the output stage.

For example, for the 8×8 routing device, the quantity of input ports of the input stage is 8, and therefore, the total quantity of 2×2 wavelength switches in the 8×8 routing device is 12, and the quantity of 2×2 wavelength switches that input optical signal passes through from the node T₁ to the node R₈ is 3. Compared with the prior art, for a 16×16 routing device, when the quantity of input ports is 16, 32 2×2 wavelength switches are needed in the present disclosure, and four 2×2 wavelength switches are passed through (while in the prior art, four optical switches need to be passed through for even a 9×9 routing device); while in the prior art, a 16×16 routing device needs a total of 48 optical switches. For a 64×64 routing device, 192 2×2 wavelength switches are needed in the present disclosure, while 448 optical switches are needed in the prior art.

Therefore, in the wavelength routing device of this embodiment of the present disclosure, the primary circuit includes N 2×2 wavelength switches and the secondary circuit includes two N×N wavelength routers; in this way, on the one hand, a topology of the wavelength routing device is simplified, and on the other hand, not only a quantity of optical switches in the routing device can be reduced, where the reduction in the quantity of optical switches is more significant for a larger optical network, but also a quantity of optical switches that input optical signal passes through in the routing device can be reduced, thereby improving efficiency of the routing device.

Persons of ordinary skill in the art may understand that all or some of the steps of the method embodiments may be implemented by a program instructing relevant hardware. The program may be stored in a computer-readable storage medium. When the program runs, the steps of the method embodiments are performed. The foregoing storage medium includes: any medium that can store program code, such as a ROM, a RAM, a magnetic disk, or an optical disc.

Finally, it should be noted that the foregoing embodiments are merely intended for describing the technical solutions of the present disclosure, but not for limiting the present disclosure. Although the present disclosure is described in detail with reference to the foregoing embodiments, persons of ordinary skill in the art should understand that they may still make modifications to the technical solutions described in the foregoing embodiments or make equivalent replacements to some or all technical features thereof, without departing from the scope of the technical solutions of the embodiments of the present disclosure.

What is claimed is:

1. A wavelength routing device comprising:
an input stage comprising 2N input ports;
an output stage comprising 2N output ports;
a primary circuit comprising N 2×2 wavelength switches; and
a secondary circuit comprising two N×N wavelength routers, each N×N wavelength router comprising a quantity of 2×2 wavelength switches,
wherein N is a positive integer, and the 2N input ports of the input stage are connected to 2N input ports of the N 2×2 wavelength switches in the primary circuit in one-to-one correspondence, wherein 2N output ports of the N 2×2 wavelength switches in the primary circuit are connected to 2N input ports of the two N×N wavelength routers in the secondary circuit in one-to-one correspondence, and wherein 2N output ports of the two N×N wavelength routers in the secondary circuit are connected to the 2N output ports of the output stage in one-to-one correspondence.

2. The device according to claim 1, wherein a quantity N1 of 2×2 wavelength switches included in the wavelength routing device is related to a quantity M1 of the input ports of the input stage according to
N=(M1/2)log₂ M1
wherein M1 is a positive integer.

3. The device according to claim 1, wherein in the wavelength routing device, a quantity N2 of 2×2 wavelength switches that each optical signal needs to pass through from an input port of the input stage to an output port of the output stage is related to a quantity M2 of the input ports of the input stage or the output ports of the output stage according to
N2=log₂ M2
wherein M2 is a positive integer.

4. The device according to claim 2, wherein in the wavelength routing device, a quantity N2 of 2×2 wavelength switches that each optical signal needs to pass through from an input port of the input stage to an output port of the output stage is related to a quantity M2 of the input ports of the input stage or the output ports of the output stage according to
N2=log₂ M2
wherein M2 is a positive integer.

5. The device according to claim 1, wherein each 2×2 wavelength switches forms an optical comb-filter having a wavelength choice characteristic.

6. The device according to claim 1, wherein a value of N corresponds to 2ⁿ, n representing a positive integer.
